(19) United States
(12) Patent Application Publication
(10) Pub. No.: US 2019/0190139 A1
(43) Pub. Date: Jun. 20, 2019

(54) INFLATABLE ANTENNA STRUCTURES AND ASSOCATED ASSEMBLIES

(71) Applicant: Shakespeare Company, LLC, Boca Raton, FL (US)

(72) Inventors: Andrew Atkinson, Yorkshire (GB); Dave Manasseh, Yorkshire (GB); Clayton Smith, Yorkshire (GB); William Eastwood, Columbia, SC (US); Vishal Pallikandi, Columbia, SC (US)

(21) Appl. No.: 16/276,142

(22) Filed: Feb. 14, 2019

Related U.S. Application Data
(63) Continuation-in-part of application No. PCT/US2018/037689, filed on Jun. 15, 2018.
(60) Provisional application No. 62/521,970, filed on Jun. 19, 2017.

(51) Int. Cl. H01Q 1/34; H01Q 1/08; H01Q 1/44

(52) U.S. Cl. CPC H01Q 1/34; H01Q 1/44; H01Q 1/081

(57) ABSTRACT

Inflatable antenna assemblies are provided, including an inflatable container having an inflated state and a deflated state, the inflatable container having an interior surface and an exterior surface, a flexible antenna extending along the interior surface or the exterior surface of the inflatable container, such that the antenna deploys to an operable, extended configuration upon inflation of the inflatable container to the inflated state, and a port configured for operable connection to an inflation mechanism to inflate the container to the inflated state. Safety device structures, such as life rafts, life preservers, life jackets, buoys, and emergency beacons, having inflatable antenna portions, are also provided.

### CROSS-REFERENCE TO RELATED APPLICATIONS

This application is a continuation-in-part of International Application No. PCT/US2018/037689, filed Jun. 15, 2018, which claims priority benefit of U.S. Provisional Application No. 62/521,970, filed Jun. 19, 2017, which are incorporated by reference herein.

### TECHNICAL FIELD

The present disclosure relates to antennas, and in particular, to inflatable structures with antennas and associated assemblies.

### BACKGROUND

Large marine antennas are often unsightly and take up a great deal of space. A typical marine antenna is composed of a rigid plastic shell surrounding an antenna that permits communications to and from a receiver and/or a transmitter. While a larger antenna may increase the antenna's range and performance, smaller vessels often do not have space for a large, permanently fixed marine antenna. Smaller vessels, instead, carry either a handheld radio or have a smaller antenna system attached to the boat. However, in an emergency, the smaller antenna system may not be sufficient to contact a nearby vessel or the coast guard. Indeed, most emergency devices, such as lifeboats, life rafts, life preservers, emergency beacons, and the like, are necessarily limited in size and space and are not amenable to carrying a large marine antenna. Such large antennas are rigid and are susceptible to damage in storm or harsh environments. Therefore, any improvements in antenna storage, range, and/or overall aesthetics would be useful.

### SUMMARY

In one aspect, an inflatable antenna assembly is provided, including an inflatable container having an inflated state and a deflated state, the inflatable container having an interior surface and an exterior surface; a flexible antenna extending along the interior surface or the exterior surface of the inflatable container, such that the antenna deploys to an operable, extended configuration upon inflation of the inflatable container to the inflated state; and a port configured for operable connection to an inflation mechanism to inflate the container to the inflated state.

In another aspect, an inflatable safety device assembly is provided, including a safety device structure; an inflatable antenna portion having a flexible antenna, the inflatable antenna portion being integral with or operably coupled to the safety device structure and having an operable inflated state in which the flexible antenna is deployed in an extended configuration and a deflated state; and a port in fluid communication with the inflatable antenna portion, the port being configured for operable connection to an inflation mechanism to inflate the inflatable antenna portion to the inflated state. For example, the safety device structure may be a life raft, a life preserver, a life jacket, a buoy, or an emergency beacon.

### BRIEF DESCRIPTION OF THE DRAWINGS

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a front perspective view of one embodiment of a bag for carrying an inflatable antenna assembly according to the concepts of the present application;

FIG. 2 is a rear perspective view of the bag of FIG. 1 having a series of loop fastener strips according to the concepts of the present application;

FIG. 3 is a side cross-sectional view of one embodiment of the inflatable antenna assembly prior to inflation according to the concepts of the present application;

FIG. 4 is a front view of one embodiment of an antenna used in the inflatable antenna assembly according to the concepts of the present application;

FIG. 5 is a partial cross-sectional plan view of one embodiment of an inflatable sock and antenna of the inflatable antenna assembly according to the concepts of the present application;

FIG. 6 is a side view of one embodiment of an inflatable antenna assembly in an inflated state according to the concepts of the present application;

FIG. 7 is a side view of another embodiment of an inflatable antenna assembly in an inflated state and coupled to a structure according to the concepts of the present application;

FIG. 8 is a top view of the inflatable antenna of FIG. 6 according to the concepts of the present application;

FIG. 9 is a side view of the inflatable antenna of FIG. 6 according to the concepts of the present application;

FIG. 10 is a schematic view of a safety device structure in the form of a life raft in an inflated condition utilizing an inflatable antenna assembly according to the concepts of the present application;

FIG. 11 is a schematic view of a safety device structure in the form of a life preserver in an inflated condition utilizing an inflatable antenna assembly according to the concepts of the present application; and

FIG. 12 is a schematic view of a safety device structure in the form of an emergency beacon in an inflated condition utilizing an inflatable antenna assembly according to the concepts of the present application.

### DETAILED DESCRIPTION

Referring now to the drawings, exemplary illustrations are shown in detail. The various features of the exemplary approaches illustrated and described with reference to any one of the figures may be combined with features illustrated in one or more other figures, as it will be understood that alternative illustrations that may not be explicitly illustrated or described may be able to be produced. The combinations of features illustrated provide representative approaches for typical applications. However, various combinations and modifications of the features consistent with the teachings of the present disclosure may be desired for particular applications or implementations. The representative illustrations described below relate generally to antennas and in particular to inflatable antenna devices and assemblies. Artisans may recognize similar applications or implementations with other technologies and configurations.

In some embodiments, an inflatable antenna assembly includes a bag (used herein to refer to any suitable container or substrate for the antenna) with a stiffened portion and an inflatable antenna attached to the stiffened portion of the bag. The inflatable antenna includes an inflatable sock with an interior surface and an exterior surface where an antenna extends along the inflatable sock. On the exterior surface of the inflatable sock is an attachment mechanism. An inflation canister is attached to the attachment mechanism and is configured to inflate the inflatable sock into an inflated state from a deflated state. The aforementioned bag contains the inflatable sock. The bag includes an interior surface and an exterior surface. On the exterior surface of the bag is a fastener configured to close an interior volume of the bag, a handle coupled to the exterior surface of the bag, and a series of loop fastener strips.

The inflatable antennas disclosed herein may be provided in various other assemblies. The inflatable antenna assembly may include the capability of efficient storage of an inflatable antenna, where the inflatable antenna may assume an inflated state only in emergency situations. The inflatable antennas described herein are efficient with increased range while also being stowable in a small volume. Potential applications for the inflatable antennas and assemblies described herein include marine, military, emergency/rescue, camping, developing nation/remote area infrastructure, and shipping.

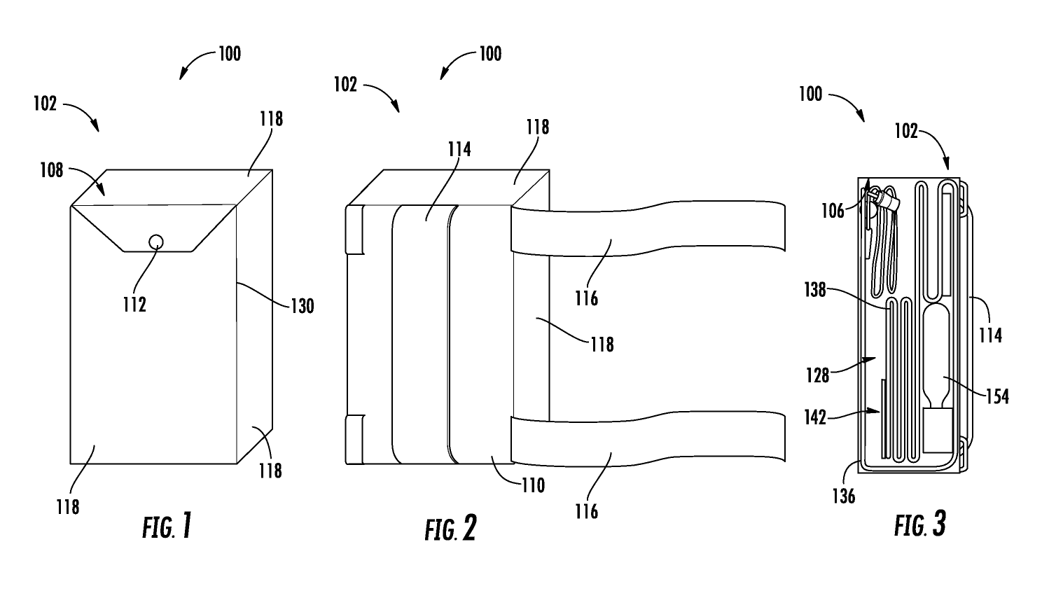

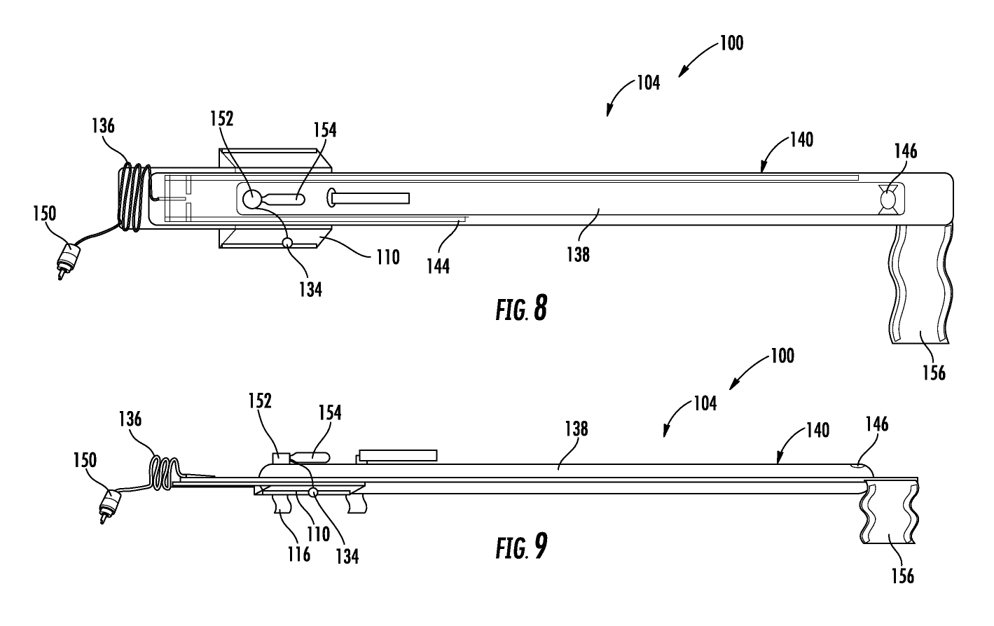

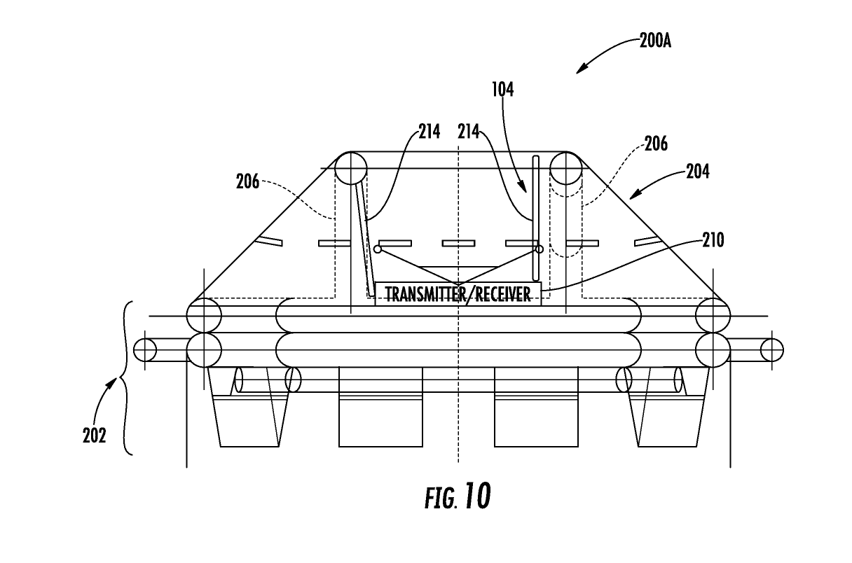

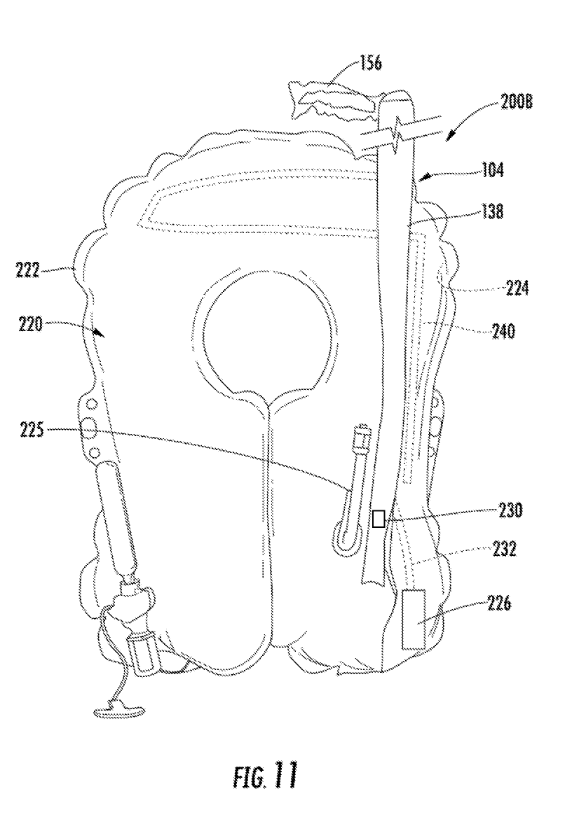

In some embodiments, as shown in FIGS. 8 and 9, the inflatable antenna assembly 100 may include an inflatable antenna 104 configured to assume an inflated state. For example, the inflatable antenna 104 may have a deflated state (see FIG. 3) and an inflated state as shown in FIGS. 8 and 9. As used herein, the phrase “inflated state” refers to the inflatable antenna system being in an expanded shape due to gas or liquid substantially filling the interior volume of the inflatable antenna. As used herein, the phrase “deflated state” refers to the antenna system being substantially empty of an expanding material such as gas or liquid.

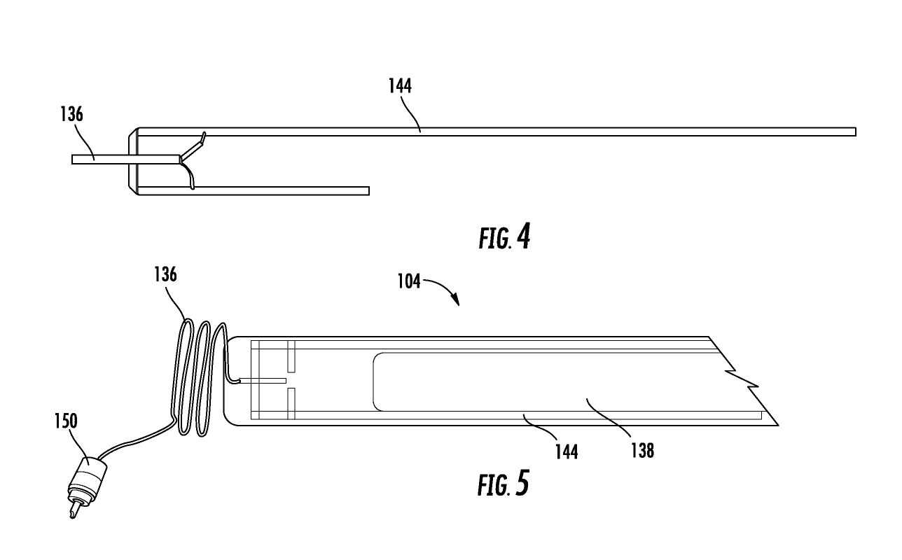

In some embodiments, as shown in FIGS. 5, 8, and 9, the inflatable antenna 104 includes an inflatable sock 138 (e.g., bladder, container) configured to expand into a predefined shape. For example, the inflatable sock 138 may expand when filled with gas to an inflated state 140 and form an elongated shape. The inflatable antenna 104 may be configured to manually or automatically inflate, such as by a suitable inflation mechanism including a pump, gas canister, or breath of a user through a suitable valve or straw, as will be discussed in greater detail below. That is, the inflation mechanism may be any suitable inflation mechanism known to provide the flow of gas effective to inflate the container. Additional inflation mechanisms are known to those skilled in the relevant art and may be integrated into the inflatable antenna systems described herein.

In some instances, the inflatable sock 138 may have a rectangular cross-sectional shape. In other instances, the inflatable sock 138 may have a circular, square, elliptical, triangular, or another type of cross-sectional shape. The inflatable sock 138 may expand to about 1.5 meters long. In certain embodiments, the inflatable sock 102 has an inflated length of at least 1 meter. For example, the inflatable sock 138 in an inflated state 140 may have a length of from about 1 meter to about 10 meters, such as from about 1 meter to about 5 meters, or from about 1 meter to about 3 meters. As used herein, the term “about” means the specified value for a particular unit of measurement may be accurate with an increase or decrease of ten percent of the specified value.

In certain embodiments as seen in FIGS. 1-3, the inflatable sock 138 may be disposed within a bag 102 or another suitable container, or associated with a suitable substrate or inflation mechanism in a deflated state 142. For example, the inflatable sock 138 in a deflated state 142 may be configured to be rolled or folded into a compact shape. For example, the inflatable sock 138 may be flat and flexible in its deflated state 142. In some instances, the inflatable sock 138 of the inflatable antenna 104 may be composed of plastic, rubber, neoprene or some other suitable material that is substantially impermeable to trapped gas or liquid. For example, the inflatable sock 138 may be substantially airtight or gastight, such that it can be inflated with air or other appropriate gas so as to unfurl or uncoil the sock and maintain an inflated state 140 for a period (e.g., at least one day, or a period of about one day to about seven days).

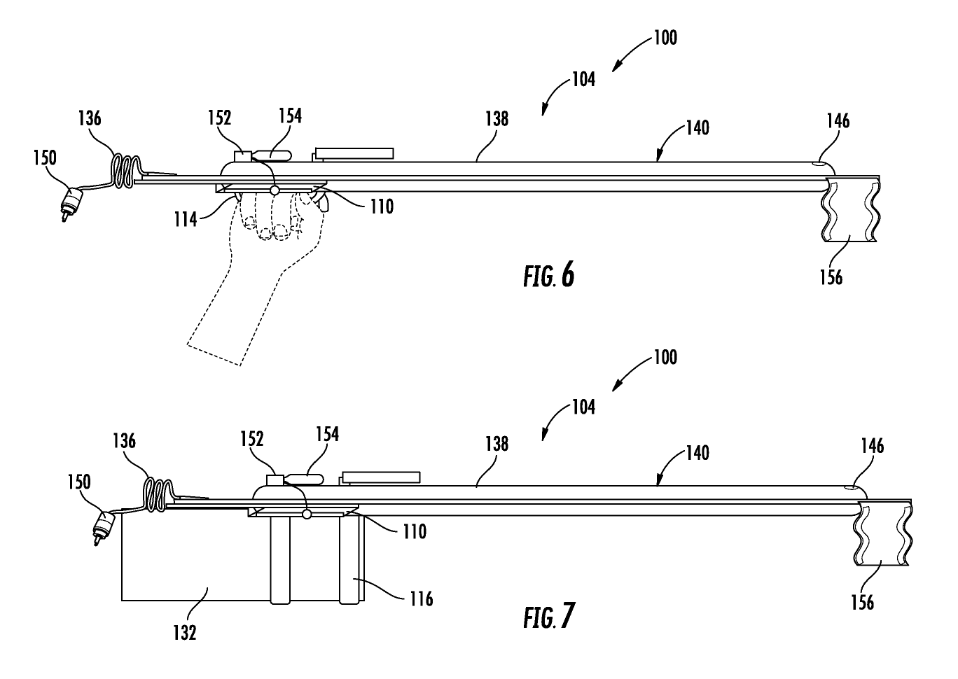

In certain embodiments, the inflatable sock 138 may include a sealable attachment port 152 (see FIGS. 6-9) configured to provide an inlet for the inflating air. For example, the inflatable sock 138 may be composed of nylon. For example, the fabric material may be a waterproof material. In another example, the fabric material may be a reflective or otherwise brightly colored and/or easy-to-see material. In some embodiments, the inflatable antenna 104 includes a light or other reflective features associated with the inflatable sock 138, such as to facilitate emergency locating.

In some embodiments, as shown in FIGS. 4 and 5, the inflatable sock 138 of the inflatable antenna 104 contains an antenna 144 (which may be formed of one or more antenna sections or portions). The antenna 144 may attach to an interior or exterior surface of the inflatable sock 138, or some combination of both. When deployed, the antenna 144 may start adjacent to the bag 102 and extend away from the bag 102 up the inflatable antenna 104 exterior surface. For example, the antenna 144 may be attached to the exterior surface of the inflatable sock 138 by adhesive or another fastener, and also covered with a layer of fabric.

In some instances, the antenna 144 may attach to another surface of the inflatable antenna 104. In some instances, the antenna 144 may be embedded within stitching of the inflatable sock 138. In some instances, the antenna 144 may be embedded within the material of the inflatable sock 138. In some instances, the antenna 144 may attach to an exterior surface of the inflatable sock 138. In some instances, the antenna 144 may extend along the entire length of the inflatable sock 138.

Thus the antenna 144 may be coupled, directly or indirectly, to at least some portion of the inflatable container 138 (e.g., sock) and/or another inflatable section or portion of the assembly or device. For example, the antenna 144 may be glued, stitched, welded, crimped, or otherwise attached directly to the material forming the inflatable container or section, or to another material or support structured associated with the material forming the inflatable container or section. For example, in certain embodiments, one or more sections of the antenna are first attached to a sheet or sleeve which is then associated to the inflatable container or a supporting structure within it.

In certain embodiments, the antenna (or the collection of sections forming the antenna) extends along the interior or exterior surface of the inflatable container (e.g., sock). Again, the antenna may be coupled directly or indirectly to the body or material forming the inflatable container. Generally, the phrase “extending along a surface of the inflatable sock/container” refers to the antenna being disposed along some length of the container, such that in the inflated state, the antenna is unfurled or uncoiled to an operable, extended configuration.

In some instances, the antenna 144 may wrap spirally or in some other manner around the inflatable sock 138. In other instances, the antenna 144 may follow one or more straight paths along the inflatable sock 138. In other instances, the antenna 144 may extend along only half a partial length, such as the distance of the length, of the inflatable sock 138. For example, the antenna 144 may extend about 70 percent of the length of the inflatable sock 138. For example, the antenna 144 may extend between about 50 percent to about 100 percent of the length of the inflatable sock 138. In certain embodiments, the antenna 144 has a length that is at least about 50 percent of the length of the inflatable sock, such as at least about 75 percent of the length of the inflatable sock, or at least about 85 percent of the length of the inflatable sock.

For example, the antennas and assemblies described herein provide an efficiently stowable full-size antenna. For example, the antenna 144 may be about 130 centimeters to about 140 centimeters. In other instances, the antenna may be less than 130 centimeters or above 140 centimeters. For example, the antenna may be at least one meter in length but stowable in a package having a major dimension of one foot or less, such as about a 10 inch or smaller container. For example, these antennas may offer an unobtrusive and resilient full 3 dB VHF antenna that can be stored in a dimension of about 250 mm or less and inflated when required. Thus, these antennas may be used in areas where VHF signal transmission is needed and where it has historically been hard to get an antenna. Conventional emergency/temporary antennas are about 6 to about 8 inches long and have limited performance (e.g., about 1 dB gain). Thus, the antennas described herein offer increased performance. Moreover, traditional extendable antennas utilize a rigid telescoping design, which is prone to breakage. The flexible whip antenna designs described herein are relatively easy to store and quickly extend to full size, without the need for careful deployment of a telescoping antenna and the risk of damaging the antenna during deployment. In other words, when in the inflated state 140, the material of the inflatable sock remains flexible or non-rigid, so as to allow the inflatable antenna to deflect at its connection point to a transmitter, as will be discussed, so as to avoid or minimize damage that might otherwise occur. The inflatable antenna is also flexible along its length to absorb any impacts and then return to its original inflated state with minimal loss of signal performance.

In some embodiments, as shown in FIG. 4, the antenna 144 is in a J-pole formation. As used herein, the phrase “J-pole formation” refers to an antenna in the formation of a “J” shape. A J-pole formation may provide broadband coverage with a low angle radiation pattern. The antenna 144 may be any other type of antenna formation, including a bow tie, log-periodic dipole array, short dipole, dipole, monopole, loop, helical, Yagi-Uda, rectangular microstrip, planar inverted-f, corner, or parabolic reflector antenna configured to be connected to a radio receiver and/or transmitter. In some instances, the antenna 144 may be configured to transmit information. In other instances, the antenna 144 may be configured to receive information. The antenna 144 may be configured to transmit and receive signals. For example, the antenna 144 may be a very high-frequency antenna (VHF). As used herein, the phrase “very high frequency” refers to a range for radio waves of about 30 megahertz (MHz) to about 300 MHz. The antenna 144 may be tuned to a frequency of from about 30 MHz to about 300 MHz. For example, the antenna may be tuned to a frequency of about 156 MHz to about 162 MHz. In some instances, the antenna 144 may be high frequency. In other instances, the antenna 144 may be ultra-high frequency. The antenna 144 may have a gain of 3 decibels (dB). In some instances, the antenna 144 may have a gain of more or less than 3 dB.

In one embodiment, the antenna 144 is a braided copper tape configured to be suitably flexible. For example, the copper tape may be configured to fold when the inflatable sock 138 is in a deflated state 142. In other instances, the antenna 144, or sections or portions thereof, may not be flexible. For example, in certain embodiments, rigid antenna elements, sections, or portions, may be flexibly connected to provide the desired flexibility of the overall antenna assembly. For example, sections of the antenna may be embedded within sections or the inflatable structure by fitting between folds thereof. The antenna 144 may be composed of another type of metal or metal alloy, such as aluminum. In some instances, the antenna 144 may be a flexible whip antenna.

In some embodiments, as shown in FIGS. 5, 8 and 9, the antenna 144 is coupled to a feed cable 136 configured to transfer information between the antenna 144 and a transmitter (not shown) and/or radio receiver (not shown). The feed cable 136 may be a radio frequency (RF) feed cable for the antenna 144. As used herein, the phrase “feed cable” refers to a cable that carries radio signals from a transmitter or receiver to the antenna. In some instances, the feed cable 136 is a coaxial cable. For example, the coaxial feed cable 136 may include an inner conductor surrounded by a dielectric insulator, which is surrounded by a tubular conducting shield, which is surrounded by an outer polymeric covering. In other instances, the feed cable 136 may be a ladder line. For example, the ladder line feed cable 136 may have two parallel wires separated by insulating material. In some embodiments, the feed cable 136 has an impedance value of 50 ohms. In other embodiments, the feed cable 136 has an impedance greater than or less than 50 ohms. At the end of the feed cable 136 may be a connector 150 that attaches to a radio or transmitter (not shown). In some instances, the connector 150 may be a coaxial connector and/or an ultra high frequency (UHF) connector. In other instances, the connector 150 may be another type of connector such as Subminiature Version A, Female Version A, Bayonet Neill-Concelman, Threaded Neill-Concelman, or Type N connector. The connector 150 may fit within the bag 102 (as shown in FIG. 3) and be configured to plug into a receiver or transmitter.

In some embodiments, as shown in FIGS. 8 and 9, the inflatable antenna assembly 100 includes a light 146. For example, the light 146 may be a light-emitting diode. The light 146 may be disposed at one end of the inflatable antenna 104. For example, such a light 146 may be powered by a battery or a separate power cord, or through a coaxial cable that connects the antenna to a radio. In the latter configuration, the power may be injected through an in-line power injector and filtered out for use at the antenna end.

In some instances, the light 146 may be a different type of light, such as a fluorescent tube, a neon lamp, a high-intensity discharge lamp, a low-pressure sodium lamp, a metal halide lamp, a halogen lamp, a compact fluorescent lamp, or an incandescent lamp. In some instances, the inflatable antenna assembly 100 may have one light 146. In other instances, the inflatable antenna assembly 100 may have multiple lights disposed along the interior and/or exterior surfaces of the inflatable antenna 104 and/or bag 102.

In some embodiments, as shown in FIGS. 6-9, the inflatable antenna assembly 100 includes a flag 156 configured to improve the visibility of the inflatable antenna 104. For example, the flag 156 may be a flexible material and lined with reflective material. For example, the flexible material may be a fabric such as cotton, linen, nylon, or other fabric. The reflective material on the flag 156 may be a fluorescent fabric. For example, having the flag 156 at one end of the inflatable antenna may increase visibility in case of rescue or signaling distress.

In some embodiments, as in FIGS. 8 and 9, the inflatable antenna 104 includes an attachment port 152 and an inflation mechanism, such as inflation canister 154 and firing pin 134. In one method, the inflation canister 154 is attached to the attachment port 152 and the firing pin 134 may be pulled to puncture the inflation canister 154. The inflation canister 154 may then release the compressed gas within the canister so as to enter the inflatable sock 138 to assume an inflated state 140 from the deflated state. In some instances, the attachment port 152 may be a one-way breathable port configured to receive air within the inflatable sock 138 to allow for manual inflation. In other instances, the attachment port 152 may be a two-way breathable port configured to receive and release air from within the inflatable sock 138. For example, the attachment port 152 may be a ball valve, butterfly valve, check valve, diaphragm valve, directional valve, float valve, knife valve, globe valve, pinch valve, needle valve, poppet valve, or plug valve. The inflatable antenna assembly 100 may have one valve or may have multiple valves along the exterior of the inflatable antenna 104.

The attachment port 152 may be configured to be coupled to a canister 154 filled with gas (i.e., in fluid communication with). In one embodiment, the canister 154 may be a carbon dioxide canister configured to be sealed until punctured by the firing pin 134. The canister 154 may be filled with another gas, such as hydrogen. In some instances, the canister 154 may be for one-time use. In other instances, the canister 154 may be refillable for multiple uses. In other instances, the inflatable sock 138 may couple to a pump configured to inflate the inflatable sock 138. The canister 154 may be a cylinder shaped to store within the bag 102 and be adaptable for replacement. For example, the cylinder may narrow at one end to attach to the attachment port 152. The narrow end of the canister may be a circular port (not shown) covered by a thin metal skin or seal. The firing pin 134 may puncture the circular port to release the gas within the canister 154. In some instances, the firing pin 134 is positioned between the canister 154 and the attachment port 152 to release air inside canister into the attachment port 152. In other instances, the firing pin 134 is located in the bag 102 and may be manually used to puncture the canister 154.

In some embodiments, as in FIGS. 1-3, an inflatable antenna assembly 100 is provided. The inflatable antenna assembly 100 includes a bag 102, an inflatable antenna 104, and, optionally, a series of other accessories contained on the interior and exterior of the bag 102. In some instances, the bag 102 may include an interior surface 106, which defines an interior volume 128, and an exterior surface 108. In some instances, the bag 102 may include multiple interior compartments (not shown) (e.g., pockets and/or dividers within the bag 102). The interior surface 106 and the exterior surface 108 may contain a variety of accessories. For example, the bag 102 may contain the inflatable antenna 104 within or on the interior surface 106 along with any additional accessories, such as flashlights, whistles, lighters, flares, knives, rations, or other survival supplies.

In some embodiments, as shown in FIG. 2, the exterior surface 108 of the bag 102 includes a stiffened portion 110, a fastener 112, a handle 114, and a series of loop fastener strips 116, among other accessories. For example, the exterior surface 108 of the bag 102 may contain reflectors, mounting apparatuses, pockets, or other structures on the bag 102. Additionally, the exterior surface 108 of the bag 102 may include a mounting fastener (not shown), such as a tie, cuff, buckle, clip, or other fastener. The bag 102 may be rigid or flexible. In some instances, the bag 102 may be nylon. In other instances, the bag 102 may be cotton, linen, wool, silk, rayon, acetate, acrylic, polyester, or some combination therein. In certain embodiments, the bag 102 may have a major dimension of about 10 inches or less. One benefit to the bag 102 being composed of nylon fabrics may be the resistance to wind and water damage.

In some embodiments, as shown in FIGS. 1-2, the bag 102 includes a plurality of walls 118 shaped as a rectangular prism. The plurality of walls 118 may form another shape, such as a cube, pyramid, cylinder, or other shape. In some instances, the plurality of walls 118 may all be rigid, solid surfaces. In other instances, some of the plurality of walls 118 may be rigid and some of the plurality of walls 118 may be flexible. For example, one wall of the plurality of walls 118 may be a stiffened portion 110. As used herein, the terms “stiffened portion” means the element is rigid under standard environmental conditions no matter the position of the element. In some instances, the stiffened portion 110 provides for a rigid base to allow for improved handling and/or inflation. In other embodiments, every wall in the plurality of walls 118 may be flexible. The plurality of walls 118, and their respective interior surfaces 106, may form an interior volume 128. In some instances, the interior volume 128 may be open to the outside environment. That is, the inflatable antenna 104 may be coupled only to the stiffened portion 110 that provides partial containment or partial coverage of the antenna.

In some embodiments, as shown in FIG. 1, the interior volume 128 of the bag 102 is closed to the outside environment. In some embodiments, a hatch, door, flap, or other suitable structure may be provided to allow for selective access to the interior volume 128. For example, one of the walls in the plurality of walls 118 may actuate about an axis (not shown) to open or close the interior volume 128. For example, one of the walls may include a fastener 112 configured to snap onto another wall to close the interior volume 128. The fastener 112 may be various types of other attachment mechanisms configured to close the interior volume. For example, the fastener 112 may be a hook-and-loop surface, button, press studs, magnetic snaps, or other attachment mechanism between two walls of the bag 102. In some instances, the plurality of walls 118 may join together by a similar attachment mechanism. For example, each seam 130 in the plurality of walls may have a hook-and-loop attachment between two walls to form the seam 130. One benefit to a hook-and-loop attachment mechanism between two walls may include the walls being easily removed from the bag 102 to release the contents of the bag 102. In other instances, the seams 130 may be formed by buttons, stitching, adhesive, or some other attachment mechanism.

In some embodiments, as shown in FIG. 2, the stiffened portion 110 of the bag 102 includes several accessories disposed thereon. For example, the stiffened portion 110 may include a handle 114 and a series of loop fastener strips 116. The handle 114 may attach to one wall of the plurality of walls 118. For example, the handle 114 may be attached to the stiffened portion 110 of the bag 102. The handle 114 may be configured to be held by a user. For example, when the seams 130 of the bag are ripped apart, the interior volume 128 opened, and the inflatable antenna 104 expanded, a user may hold onto the handle to raise, lower, or adjust the positioning of the inflatable antenna 104 (e.g., as shown in FIG. 6).

In some embodiments, as shown in FIGS. 2 and 7, the stiffened portion 110 includes a series of loop fastener strips 116 configured to attach the bag 102 to a structure 132. In some instances, the structure may be in the form of an inflatable life raft, a boat, a shipping container, or other suitable structure. For example, each loop fastener strip 116 may be a flexible fabric coupled to the bag 102 at one end and extend therefrom. The loop fastener strip 116 may wrap around the structure 132 (e.g., as shown in FIG. 7) to temporarily couple the inflatable antenna assembly 100 to a single, stable position. For example, the loop fastener strip 116 end, opposite the end coupled to the bag 102, may wrap around a structure 132 and attach to a fastener on the bag. For example, the bag 102 may have the loop portion of a hook-and-loop attachment mechanism, and the loop fastener strip 116 may include the hook portion of the hook-and-loop attachment mechanism. In some instances, the hook-and-loop mechanism may be disposed on the bag 102 and loop fastener strip 116 in another fashion.

In some embodiments, as shown in FIG. 3, the bag 102 includes an inflatable antenna 104 and other accessories within the bag 102. The inflatable antenna 104 within the bag may be in a deflated state, and each of the accessories may fit within the closed interior volume 128. For example, an inflation mechanism, such as inflation canister 154 and firing pin 134, a feed cable 136, and other accessories may be disposed therein.

In the embodiments described above, an inflatable antenna assembly 100 is disclosed, wherein the assembly 100 may be attached to a structure 132 with fasteners 112 extending from the bag 102 so that the antenna is securely held to the structure. Some of the structures identified above include, but are not limited to, an inflatable life raft, a boat, a shipping container, or other suitable structure. Other suitable structures may include life preservers, life jackets, buoys, and emergency beacons, to name a few. The structures may also be utilized with handheld radios and the like. Going forward, these structures may be identified as safety device structures. As discussed above, the inflatable antenna system may be used to replace existing antenna systems with short length antennas so as to effectively increase the transmission power of the associated transmitter or receiver. As a result, the range of an emergency signal is effectively expanded.

In addition to retrofitting existing structures, the concepts and embodiments described above can be made integral to a safety device structure to further enhance the effectiveness of the inflatable antenna assembly. To that end, all of the features and advantages described above are available to be incorporated into the safety device structures described below. To name a few, the materials used for the sock, the different types of antennas, the connectors employed by the antennas, the feed cables, the valves, and various lights, may be incorporated into any of the embodiments discussed below.

Referring now to FIG. 10, it can be seen that a safety device structure is designated generally by the numeral 200A. As shown, the structure 200A may be a life raft in an inflated condition. The structure 200A provides for a flotation section 202 configured to provide flotation to the life raft and that may provide a canopy 204 supported by column supports 206. Skilled artisans will appreciate that the column supports are substantially hollow and may be inflated upon inflation with the flotation section by compressed air gas canisters in any manner known in the art. The safety device structure carries within the flotation section 202 or other appropriate compartment a transmitter/receiver 210 that may be activated upon an emergency situation.

Given the size of the safety device structure, which may be any structure sized to carry any number of passengers from 2 to 500, the column supports 206 provide for a volume in which an antenna 214 may be maintained therein or associated therewith (two such configurations are illustrated). The antenna 214 is connected to the transmitter/receiver 210 and provides for a sufficient length so as to effectively increase the antenna range as described in the previous embodiments. Skilled artisans will appreciate that any of the different types of antennas described above may be employed within the support 206 or, for that matter, in any other flotation section 202 of the structure. However, in some embodiments, the inflatable antenna assembly 100 as described above, and in particular the inflatable antenna 104, may be used or provided as a separate configuration so that the antenna may extend beyond the canopy 204. In this regard, the antenna 104 may be associated with the safety device structure 200A in a manner similar to that shown in FIG. 7 where the antenna 104 is associated with the structure 132.

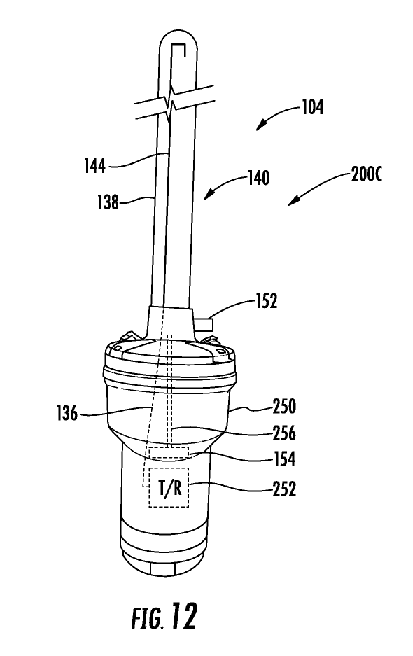

Referring now to FIG. 11, it can be seen that an alternative safety device structure is designated generally by the numeral 200B. In this embodiment, the safety device structure 200B is a life jacket or life preserver, which may also be referred to as an automatic identification system (AIS). In this embodiment, the safety device structure 200B provides for a flotation section 220 configured to provide flotation to the device upon inflation, and which provides for an exterior surface 222 opposite an interior surface 224. The structure may provide for a manual inflation mechanism 225, which allows the person using the flotation section 220 to manually inflate the flotation section along with the inflatable sock 138 as will be described. In another embodiment, an automated inflation mechanism 226 may be employed which employs a canister of compressed gas as described in the embodiments above to inflate the flotation section 220 and/or the inflatable sock 138. Although the canister of the device 226 is shown to be external to the structure 200B, skilled artisans will appreciate that the canister may be maintained internally within the flotation section 220 with provisions for actuating it externally of the flotation section. The safety device structure also provides for a transmitter/receiver 230 which may be activated upon actuation of the canister or some other detected condition.

The safety device structure 200B carries the inflatable antenna 104 as described above in the other embodiments. The inflatable antenna may be actuated by either the manual inflation device 225 or the automated inflation device 226. As in the previous embodiments, the inflatable antenna 104 provides for an inflatable sock 138 that may be fluidly coupled to the inflation devices 225 and/or 226. To this end, a conduit 232 may be connected between the inflatable sock 138 and the valve used for the manual inflation device 225, or directly to the device 226. Skilled artisans will further appreciate that the inflatable sock 138 is flexible at its base with respect to its attachment either to the transmitter/receiver 230 or to the flotation section 220. In other words, the inflatable sock 138 may be fluidly connected to the flotation section such that inflation of the flotation section also provides for inflation of the inflatable sock 138. Accordingly, the inflatable sock, as described above, may extend any of the lengths discussed above to effectively increase the range in which the transmitter/receiver may broadcast or receive signals.

In another embodiment, the flotation section may internally and/or externally maintain an antenna 240. As a result, the antenna unfurls and/or uncoils as the flotation section inflates, wherein the effective antenna length is distributed about the surface interior and/or exterior surface area of the flotation section, thus effectively increasing the range of the antenna.

Referring now to FIG. 12, it can be seen that a safety device structure is designated generally by the numeral 200C. In this embodiment, the inflatable antenna 104 is associated with an emergency beacon wherein the emergency beacon may be of any number of configurations. These configurations may be in any form, such as an emergency positioning radio beacon (EPIRB), personal locator beacons (PLB), personal automated identification system (AIS) devices, search and rescue transponders (SART), emergency locator transmitters (ELT), VHF marine radios, and any other transceiver configuration where a compact inflatable antenna is desirable.

Such a structure 200C provides for a housing 250, which may be floatable or not, wherein the housing carries a transmitter/receiver 252, designated as “T/R” in FIG. 12. The inflatable antenna 104 may be coupled to the housing 250 and provides the inflatable sock 138, which may be inflated manually or automatically as described in any of the embodiments above. The inflatable sock 138 carries the antenna 144, which may be a J-type, or other type of antenna as described in the embodiments above. A manual valve 152 may be provided near the base of the inflatable sock to allow for manual inflation thereof. In another embodiment, a compressed gas canister 154, which is connected to a conduit 256 at one end, wherein the other end of the conduit is connected to the inflatable sock 138, may be provided. Mechanisms may be provided within the housing 250 for manual or automatic actuation of the canister to enable inflation of the antenna.

From the foregoing, advantages of the present embodiments are readily apparent. The embodiments provide for configuration of an antenna that may be inflated along with flotation sections provided by a life raft and/or life preserver, with or without a separate inflatable sock structure. For example, these embodiments may include an inflatable sock so that the inflation of the antenna does not rely solely on inflation of the structure; however, in certain embodiments in which the antenna is integrated with the inflatable flotation section of a safety device structure separate from an inflatable sock, inflation of the safety device structure alone is sufficient to unfurl/uncoil the antenna into an operable position.

Thus, the described embodiments provide for an increased length antenna, which provides for significantly improved range so as to facilitate search and rescue of individuals on life rafts, life preservers, or associated with emergency beacons. Further, enclosed antennas, in which the antennas are maintained within a structure which is inflatable, may be advantageous in that the antennas are somewhat protected from harsh or adverse conditions that may be encountered during emergency situations. Additionally, the described safety device structures may be advantageous in that such configurations provide for a flexible antenna which allows for the antenna to be exposed to harsh environments, but which is able to deflect at high winds without damage to the antenna itself.

While the disclosure has been described with reference to a number of embodiments, it will be understood by those skilled in the art that the disclosure is not limited to such disclosed embodiments Rather, the disclosed embodiments can be modified to incorporate any number of variations, alterations, substitutions, or equivalent arrangements not described herein, but which are commensurate with the scope of the disclosure.

What is claimed is:

1. An inflatable antenna assembly, comprising:
an inflatable container having an inflated state and a deflated state, the inflatable container having an interior surface and an exterior surface;
a flexible antenna extending along the interior surface or the exterior surface of the inflatable container, such that the antenna deploys to an operable, extended configuration upon inflation of the inflatable container to the inflated state; and
a port configured for operable connection to an inflation mechanism to inflate the container to the inflated state.

2. The inflatable antenna assembly of claim 1, wherein the inflatable container comprises a safety device structure.

3. The inflatable antenna assembly of claim 2, wherein the safety device structure is a life raft, a life preserver, a life jacket, a buoy, or an emergency beacon.

4. The inflatable antenna assembly of claim 2, wherein the inflatable container comprises a flotation section of the safety device structure, the flotation section being configured to provide flotation to the inflatable antenna assembly.

5. The inflatable antenna assembly of claim 4, wherein the flexible antenna extends along at least a portion of the flotation section.

6. The inflatable antenna assembly of claim 2, further comprising an inflatable flotation section coupled to the container and configured to provide flotation to the inflatable antenna assembly upon inflation.

7. The inflatable antenna assembly of claim 6, wherein the container is in fluid communication with the flotation section such that the container is configured to inflate upon inflation of the flotation section.

8. The inflatable antenna assembly of claim 6, wherein the container is an elongated sock in the inflated state.

9. The inflatable antenna assembly of claim 1, wherein the inflatable container comprises a life raft comprising a canopy supported by at least one inflatable column.

10. The inflatable antenna assembly of claim 9, wherein the flexible antenna extends at least partially along the at least one inflatable column.

11. The inflatable antenna assembly of claim 1, wherein the inflatable container is coupled to an inflatable life preserver or life jacket, such that the container is inflated to its inflated state upon inflation of the inflatable life preserver or life jacket.

12. The inflatable antenna assembly of claim 11, wherein the inflatable life preserver or life jacket is configured for manual inflation.

13. The inflatable antenna assembly of claim 1, wherein the inflatable container comprises at least a portion of an inflatable life preserver or life jacket.

14. The inflatable antenna assembly of claim 1, further comprising an inflation canister coupled to the port and configured to selectively inflate the inflatable container to assume the inflated state.

15. The inflatable antenna assembly of claim 1, further comprising a transmitter and/or receiver in communication with the antenna.

16. An inflatable safety device assembly, comprising:
a safety device structure;
an inflatable antenna portion comprising a flexible antenna, the inflatable antenna portion being integral with or operably coupled to the safety device structure and having an operable inflated state in which the flexible antenna is deployed in an extended configuration and a deflated state; and
a port in fluid communication with the inflatable antenna portion, the port being configured for operable connection to an inflation mechanism to inflate the inflatable antenna portion to the inflated state.

17. The inflatable safety device assembly of claim 16, wherein the safety device structure is a life raft, a life preserver, a life jacket, a buoy, or an emergency beacon.

18. The inflatable safety device assembly of claim 16, wherein the safety device structure is a life raft comprising a flotation section configure to provide flotation to the assembly and a canopy supported by at least one inflatable column that comprises the inflatable antenna portion.

19. The inflatable safety device assembly of claim 16, further comprising an inflation canister coupled to the port and configured to selectively inflate the inflatable container to assume the inflated state.

20. The inflatable safety device assembly of claim 16, further comprising a transmitter and/or receiver in communication with the flexible antenna.
